(19) United States
(12) Patent Application Publication
(10) Pub. No.: US 2026/0062088 A1
(43) Pub. Date: Mar. 5, 2026

(54) FRAME STRUCTURE

(71) Applicant: SUZUKI MOTOR CORPORATION, Hamamatsu-shi (JP)

(72) Inventors: Naoto HORI, Hamamatsu-shi (JP); Takeshi KONNO, Hamamatsu-shi (JP); Togo OE, Hamamatsu-shi (JP); Shinichi YAMADA, Hamamatsu-shi (JP)

(73) Assignee: SUZUKI MOTOR CORPORATION, Hamamatsu-shi (JP)

(21) Appl. No.: 19/235,375

(22) Filed: Jun. 11, 2025

(30) Foreign Application Priority Data
Aug. 27, 2024 (JP) 2024-145686

(51) Int. Cl. B62K 11/04; B62J 31/00

(52) U.S. Cl. CPC B62K 11/04; B62J 31/00

(57) ABSTRACT

A frame structure of a straddle-type vehicle in which a vehicle body frame is used as an oil tank. The frame structure includes a head pipe located at a front portion of the vehicle body frame, a rear plate connecting left and right tank rails, at an upper rear side of the head pipe, a down frame having a tubular shape and extending downward from a lower rear side of the head pipe, a reinforcement connected to a rear surface of the down frame, below the rear plate, and an oil inlet attached to the rear plate and forming an oil injection port. An oil storage space is formed on inner sides of the down frame and the reinforcement. The oil inlet penetrates the rear plate and enters the storage space.

### CROSS-REFERENCE TO RELATED APPLICATIONS

This application is based on and claims priority under 35 USC 119 from Japanese Patent Application No. 2024-145686 filed on Aug. 27, 2024, the entire content of which is incorporated herein by reference.

### TECHNICAL FIELD

The present disclosure relates to a frame structure of a straddle-type vehicle.

### BACKGROUND ART

It is known that the vehicle body frame of a straddle-type vehicle is used as an oil tank for a dry sump engine (for example, see JP2729950B). In the vehicle body frame described in JP2729950B, left and right tank rails extend rearward from the upper portion of a head pipe, and one down frame extends downward from the lower portion of the head pipe. The left and right tank rails and the one down frame are connected by left and right bridge tubes, and a plate is connected to the outer surfaces of the frames so as to cover a space surrounded by the frames. The space on the inner side of the plate is connected to the frames through an opening, and the oil tank is formed in the front portion of the vehicle body frame.

Since the oil tank described in JP2729950B is formed by connecting a large number of components, it is difficult to ensure the airtightness, and due to a decrease in productivity, the cost increases and the work load of the leak test increases. Since the frames are used as the oil tank, openings are formed in the frames, and the frame rigidity is reduced.

### SUMMARY OF INVENTION

Aspect of non-limiting embodiments of the present disclosure relates to provide a frame structure that can ensure the airtightness and frame rigidity when a vehicle body frame is used as an oil tank.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a frame structure of a straddle-type vehicle in which a vehicle body frame is used as an oil tank, the frame structure including:
a head pipe located at a front portion of the vehicle body frame;
a rear plate connecting left and right tank rails, at an upper rear side of the head pipe;
a down frame having a tubular shape and extending downward from a lower rear side of the head pipe;
a reinforcement connected to a rear surface of the down frame, below the rear plate; and
an oil inlet attached to the rear plate and forming an oil injection port,
in which an oil storage space is formed on inner sides of the down frame and the reinforcement, and
wherein the oil inlet penetrates the rear plate and enters the storage space.

### BRIEF DESCRIPTION OF DRAWINGS

Exemplary embodiment(s) of the present invention will be described in detail based on the following figures, wherein:

FIG. 1 is a left side view of a straddle-type vehicle according to the present embodiment;

FIG. 2 is a partial cross-sectional view of a vehicle body frame according to a comparative example;

FIG. 3 is a left side view of the periphery of an engine according to the present embodiment;

FIG. 4 is a rear view of a sub COMP of a vehicle body frame according to the present embodiment;

FIG. 5 is a side view of the sub COMP of the vehicle body frame according to the present embodiment;

FIG. 6 is a cross-sectional view of the periphery of the engine in FIG. 3 taken along a line VI-VI; and

FIG. 7 is a cross-sectional view of the sub COMP of the vehicle body frame in FIG. 4 taken along a line VII-VII.

### DESCRIPTION OF EMBODIMENTS

A straddle-type vehicle according to an aspect of the present disclosure uses a vehicle body frame as an oil tank. In a frame structure in the straddle-type vehicle, a head pipe is located at a front portion of the vehicle body frame, a rear plate to which left and right tank rails can be connected is located at an upper rear side of the head pipe, and a down frame extends downward from a lower rear side of the head pipe. A reinforcement is connected to a rear surface of the down frame below the rear plate, and an oil inlet is attached to the rear plate to form an oil injection port. An oil storage space is formed on the inner side of the down frame and the reinforcement, and the oil inlet penetrates the rear plate and enters the storage space. Since the left and right tank rails do not constitute the oil tank, the number of components of the oil tank is reduced, the connecting portion is minimized, and the airtightness is easily ensured. Since the leak test can be performed in the sub COMP state in which the tank rail can be connected later, it is possible to reduce the work load of the worker due to the miniaturization of the test device and the weight reduction of the frame. The rigidity of the frame is increased by the oil inlet penetrating the rear plate and the oil inlet functioning as a reinforcing member.

### Embodiment

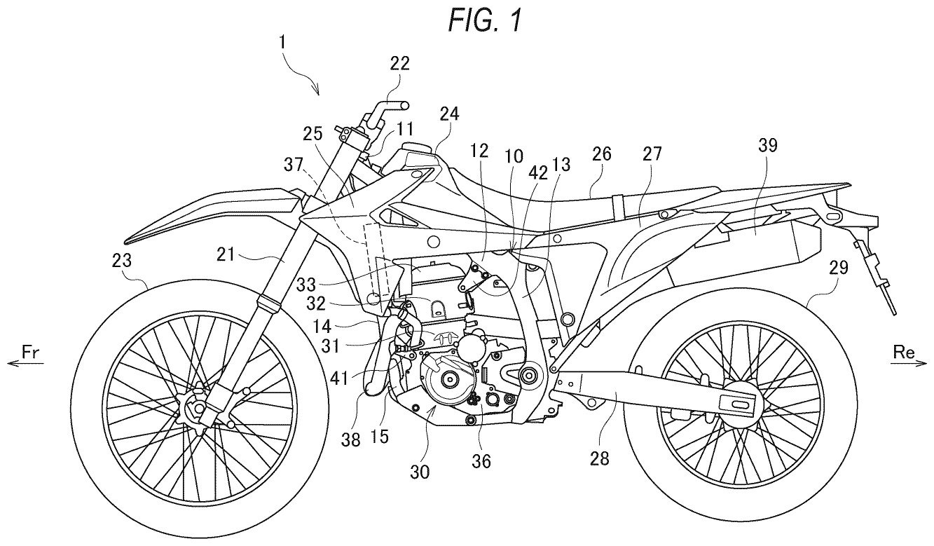

Hereinafter, a straddle-type vehicle according to the present embodiment will be described with reference to the accompanying drawings. FIG. 1 is a left side view of the straddle-type vehicle according to the present embodiment. In the following drawings, an arrow Fr indicates the vehicle front side, an arrow Re indicates the vehicle rear side, an arrow L indicates the vehicle left side, and an arrow R indicates the vehicle right side.

As shown in FIG. 1, a straddle-type vehicle 1 is implemented by mounting various components such as an engine 30 and an electrical system on a vehicle body frame 10. Left and right tank rails 12 extend obliquely rearward and downward from a head pipe 11 of the vehicle body frame 10, and a pair of body frames 13 extend downward from the rear portions of the left and right tank rails 12. A down frame 14 extends downward from the head pipe 11, and an under loop 15 bent rearward is connected to the lower portion of the down frame 14. The rear end portions of the pair of under loops 15 are connected to the lower portions of the pair of body frames 13, so that the vehicle body frame 10 is formed into a cradle shape.

A front fork 21 is steerably supported on the head pipe 11 via a steering shaft (not shown). A handle 22 is provided at the upper portion of the front fork 21, and a front wheel 23 is rotatably supported on the lower portion of the front fork 21. A fuel tank 24 is placed over the upper portion of the pair of tank rails 12, and the tank rails 12 and the fuel tank 24 are covered by front side covers 25 from the lateral sides. A seat 26 is provided rearward of the fuel tank 24, and a seat frame (not shown) supporting the seat 26 from below is covered by rear side covers 27 from the lateral sides.

A swing arm 28 is swingably supported on the body frame 13. The swing arm 28 extends rearward from the body frame 13, and a rear wheel 29 is rotatably supported at the rear end of the swing arm 28. The engine 30 is a four-stroke single-cylinder engine, and is suspended on the inner side of the vehicle body frame 10 via a plurality of suspension brackets 41 and 42. A cylinder assembly in which a cylinder 31, a cylinder head 32, and a cylinder head cover 33 are stacked is attached to the upper surface of a crankcase 36 of the engine 30. An air cleaner (not shown) is provided rearward of the cylinder head 32.

Left and right radiators 37 (only the right radiator 37 is shown in FIG. 1) are located in front of the cylinder head 32, and the left and right radiators 37 are attached to the down frame 14. An exhaust pipe 38 extends downward from the left side of the front surface of the cylinder head 32, and the exhaust pipe 38 passes through the right lateral side of the cylinder 31 and is connected to a muffler 39 on the vehicle rear side. The engine 30 uses a dry sump lubrication system in which a large oil tank is not provided in the lower portion of the crankcase 36. In the straddle-type vehicle 1 according to the present embodiment, a part of the vehicle body frame 10 is used as the oil tank.

A configuration has also been studied in which the vehicle body frame is used as the oil tank as a whole. In this case, the airtightness needs to be ensured using the vehicle body frame including a plurality of frame members as a frame component (frame COMP). When a leak test for ensuring the airtightness is performed on the vehicle body frame, a test device becomes large and the vehicle body frame becomes heavy, which increases the work load of the worker. The number of connecting portions between the frame members of the vehicle body frame increases, and it is difficult to ensure the airtightness. A communication hole connecting the frames is required, and the rigidity is reduced.

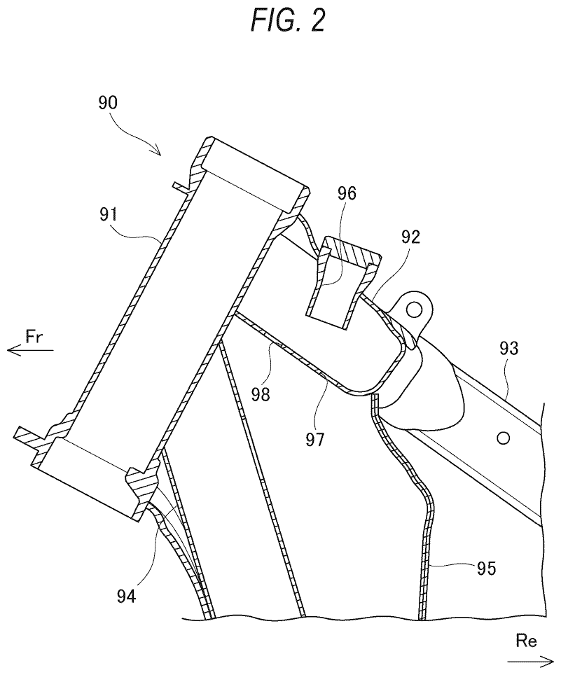

As shown in FIG. 2, a configuration has also been studied in which a part of the vehicle body frame is used as the oil tank. For example, left and right tank rails 93 are connected to the rear side of a head pipe 91 of a vehicle body frame 90 via a rear plate 92, and a reinforcement 95 is connected to the rear side of a down frame 94 and the lower side of the rear plate 92. The rear plate 92, the down frame 94, and the reinforcement 95 form an oil storage space. An oil injection port 96 is formed in the upper portion of the rear plate 92, and a communication hole 97 for dropping oil and an air hole 98 serving as a passage for air are formed in the lower portion of the rear plate 92.

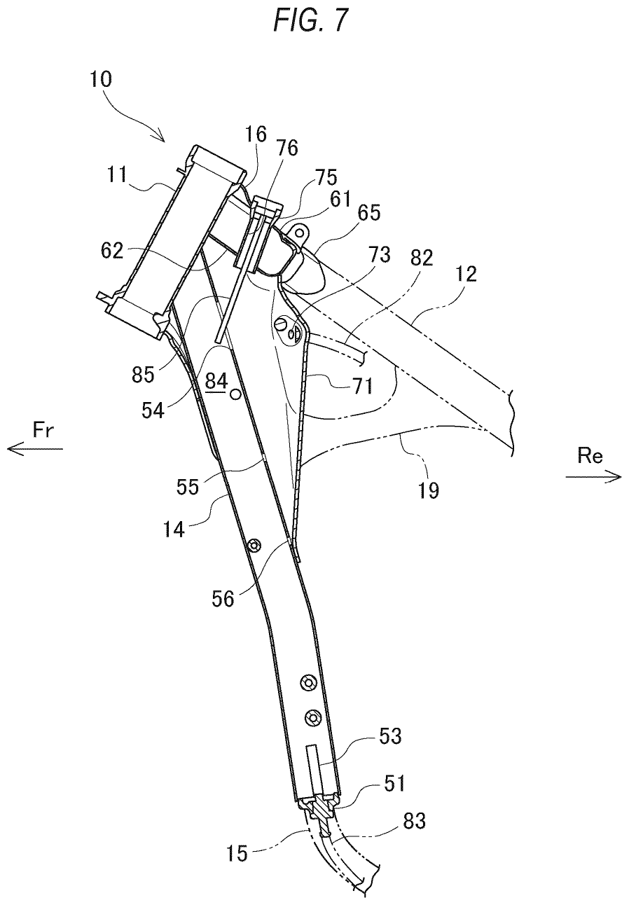

However, in the vehicle body frame 90 according to the comparative example shown in FIG. 2, since a plurality of holes such as the oil injection port 96, the communication hole 97, and the air hole 98 are formed in the rear plate 92, it is difficult to ensure sufficient frame rigidity. It is necessary to consider the shape of the peripheral components such that the plurality of holes are not blocked at the time of connecting the frames, and the shape of the components becomes complicated. Therefore, in the frame structure of the straddle-type vehicle 1 according to the present embodiment, the number of components of the oil tank is reduced to ensure the airtightness, and an oil inlet 75 (see FIG. 7) penetrates the rear plate 16 to increase the frame rigidity while forming the oil injection port.

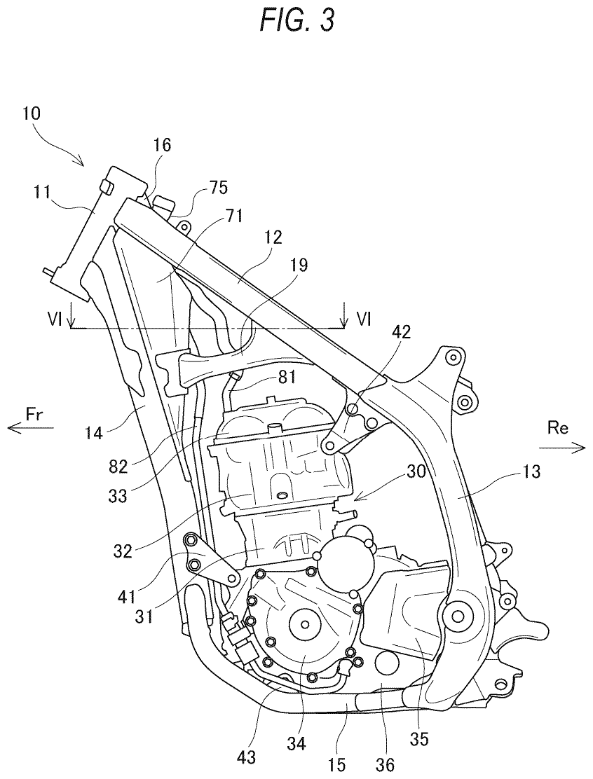

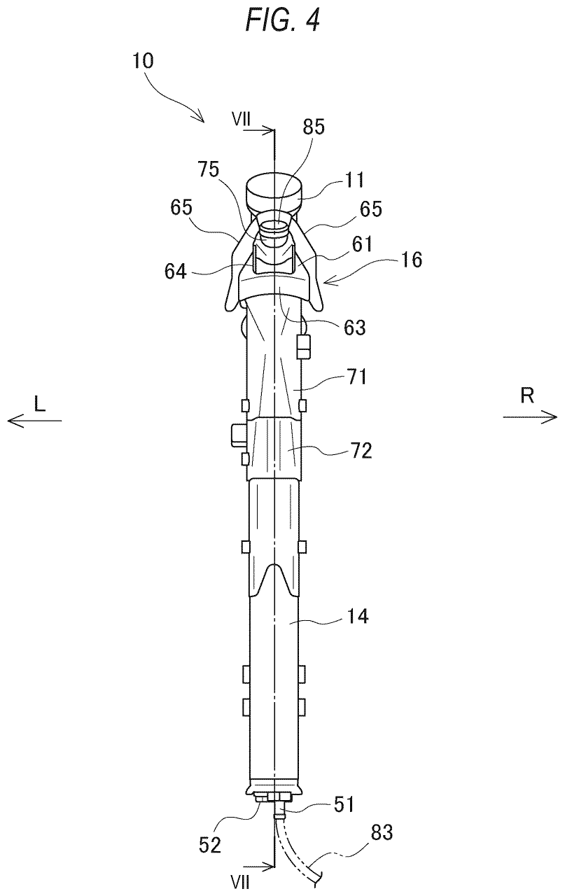

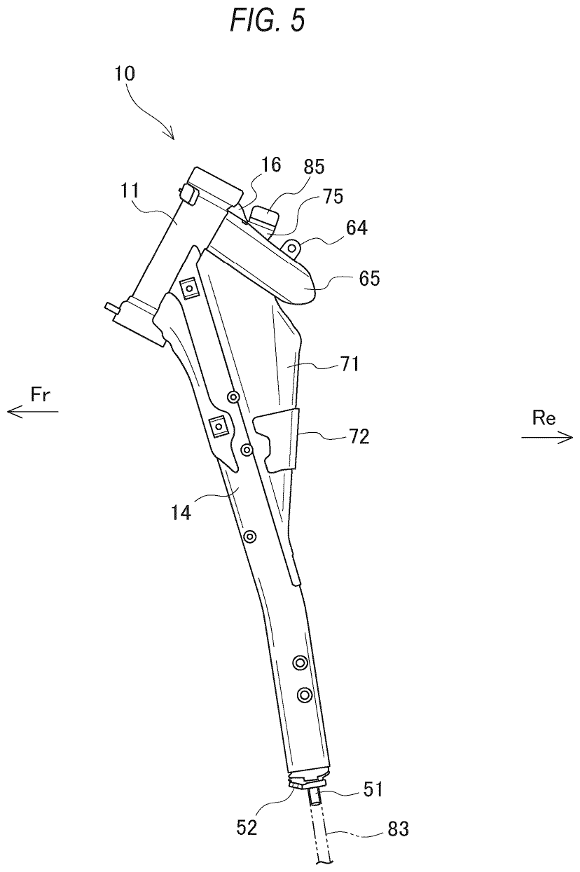

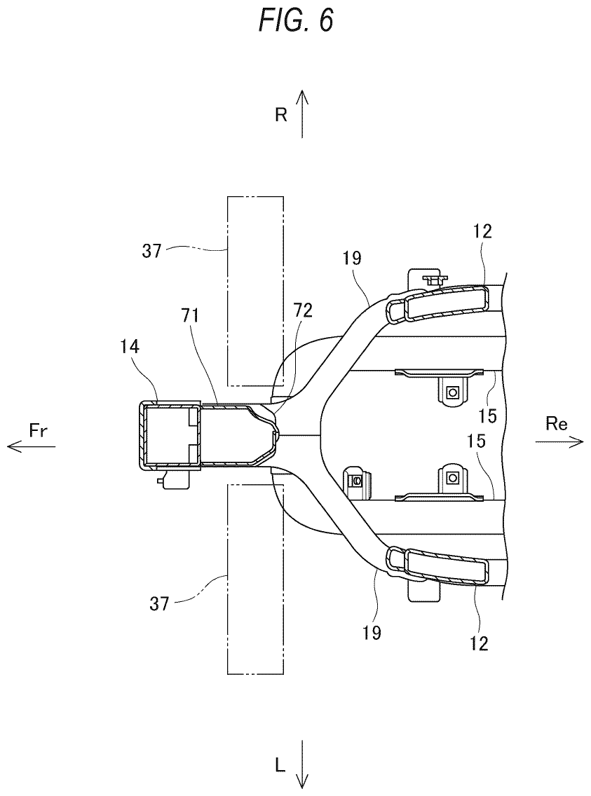

The frame structure will be described with reference to FIGS. 3 to 7. FIG. 3 is a left side view showing the frame structure according to the present embodiment. FIG. 4 is a rear view of a sub COMP of the vehicle body frame according to the present embodiment. FIG. 5 is a side view of the sub COMP of the vehicle body frame according to the present embodiment. FIG. 6 is a cross-sectional view of the periphery of the engine in FIG. 3 taken along a line A-A. FIG. 7 is a cross-sectional view of the sub COMP of the vehicle body frame in FIG. 4 taken along a line B-B. In FIG. 6, the radiator is indicated by a two-dot chain line, and the engine is omitted.

As shown in FIG. 3, the head pipe 11 is located at the front portion of the vehicle body frame 10, the rear plate 16 is connected to the upper rear side of the head pipe 11, and the down frame 14 is connected to the lower rear side of the head pipe 11. The left and right tank rails 12 are connected to the head pipe 11 and the rear plate 16. The down frame 14 extends downward from the lower rear side of the head pipe 11. A reinforcement 71 is connected to the rear surface of the down frame 14 below the rear plate 16, and the down frame 14 is reinforced by the reinforcement 71.

The oil inlet 75 is attached to the rear plate 16, and an oil injection port is formed in the vehicle body frame 10 by the oil inlet 75. In the present embodiment, the down frame 14 and the reinforcement 71 are used as the oil tank. The pair of tank rails 12 and the reinforcement 71 are connected via a reinforcing bridge tube (a bridge) 19. The engine 30 is supported on the vehicle body frame 10 below the bridge tube 19. A magneto cover 34 is provided on the left side surface of the crankcase 36 of the engine 30, and a sprocket cover 35 is provided behind the magneto cover 34.

The cylinder 31 is provided on the upper surface of the crankcase 36, the cylinder head 32 is provided on the upper surface of the cylinder 31, and the cylinder head cover 33 is provided on the upper surface of the cylinder head 32. The front portion of the crankcase 36 is supported on the down frame 14 via the suspension bracket 41, the rear portion of the cylinder head 32 is supported on the tank rail 12 via a suspension bracket 42, and the lower portion of the crankcase 36 is supported on the under loop 15 via a suspension bracket 43. An overflow hose 81 extends from the cylinder head cover 33 to the down frame 14, and an oil hose 82 for collection extends from the crankcase 36 to the reinforcement 71.

As shown in FIGS. 4 and 5, the subcomponent (sub COMP) of the vehicle body frame 10 is formed by connecting the head pipe 11, the down frame 14, the reinforcement 71, the rear plate 16, left and right rail plates 65, and the oil inlet 75. The head pipe 11 is formed in a cylindrical shape, and the upper end edge of the tubular down frame 14 is connected to the lower side of the rear surface of the head pipe 11. A connection portion 51 is provided on the lower end surface of the head pipe 11, and a supply oil hose 83 extends from the connection portion 51 to the lower portion of the crankcase 36. A drain bolt 52 is provided adjacent to the connection portion 51 on the lower end surface of the head pipe 11.

The reinforcement 71 is connected to the rear surface of the down frame 14, and the reinforcement 71 extends along the down frame 14 in the upper-lower direction. An oil storage space 84 (see FIG. 7) is formed on the inner side of the down frame 14 and the reinforcement 71. The upper surfaces of the down frame 14 and the reinforcement 71 are open, the upper end edge of the down frame 14 is connected to the head pipe 11, and the upper end edge of the reinforcement 71 is connected to the rear plate 16 and the left and right rail plates 65. A pedestal 72 to which the bridge tube 19 (see FIG. 3) is connected is provided on the rear surface of the reinforcement 71.

The rear plate 16 is formed by connecting an upper surface plate 61 and a lower surface plate 62 (see FIG. 4) by a rear surface plate 63. The upper surface plate 61 and the lower surface plate 62 are formed in a substantially triangular shape whose left-right width increases from the front end toward the rear. The front ends of the upper surface plate 61 and the lower surface plate 62 are connected to the rear surface of the head pipe 11. The left and right surfaces of the rear plate 16 are open, and the left and right rail plates 65 are connected to both side edges of the rear plate 16. The rail plate 65 has a shape conforming to the inner surface of the tank rail 12, and the inner surface of the tank rail 12 is easily connected to the rail plate 65.

An attachment plate 64 is provided on the rear side of the upper surface of the upper surface plate 61, and the attachment plate 64 is formed such that the front portion of the fuel tank 24 (see FIG. 1) can be attached thereto. Insertion holes are formed in the upper surface plate 61 and the lower surface plate 62, and the oil inlets 75 are connected to the insertion holes of the upper surface plate 61 and the lower surface plate 62. The oil inlet 75 is formed in a pipe shape, and the rigidity of the rear plate 16 is increased by the oil inlet 75. An oil injection port 76 (see FIG. 7) is formed in the oil inlet 75, and an oil level gauge 85 is inserted into the oil injection port 76.

In this way, the reinforcement 71 is connected to the rear surface of the down frame 14, and the down frame 14 and the reinforcement 71 constitute the oil tank. The left and right tank rails 12 is configured to be connected to the rear plate 16 via the left and right rail plates 65, and the rear plate 16 and the left and right rail plates 65 airtightly close the opening in the upper surface of the reinforcement 71. The leak test can be performed in the sub COMP state of the vehicle body frame 10 in which the left and right tank rails 12 can be connected later, and it is possible to reduce the work load of the worker due to the miniaturization of the test device and the weight reduction of the frame.

As shown in FIG. 6, the left and right bridge tubes 19 for connecting the reinforcement 71 and the left and right tank rails 12 are connected to the pedestal 72 of the reinforcement 71. The reinforcement 71 is connected to the left and right tank rails 12 via the left and right bridge tubes 19, thereby ensuring the frame rigidity. The bridge tube 19 is connected not to the down frame 14 but to the reinforcement 71 on the rear side of the down frame 14, so that the bridge tube 19 is less likely to affect the layout of the peripheral components of the down frame 14, and an increase in the size of the vehicle body can be avoided.

More specifically, installation spaces for the left and right radiators 37 are ensured on both sides of the down frame 14 and the reinforcement 71. The pedestal 72 is provided on the rear surface of the reinforcement 71, and the left and right bridge tubes 19 are connected to the rear surface of the reinforcement 71. Since the left and right bridge tubes 19 are connected to the reinforcement 71 behind the left and right radiators 37, it is not necessary to move the radiators 37 forward of the down frames 14 or separate the radiators 37 outward from the down frames 14 in the vehicle width direction. Therefore, an increase in the wheel base and the vehicle width dimension can be prevented.

As shown in FIG. 7, the oil storage space 84 is formed in the front portion of the vehicle body frame 10 by the down frame 14 and the reinforcement 71. The oil inlet 75 penetrates the upper surface plate 61 and the lower surface plate 62 of the rear plate 16 and enters the storage space 84. The oil injection port 76 of the oil inlet 75 is connected to the storage space 84, and engine oil is injected from the oil injection port 76 into the storage space 84. The oil level gauge 85 is inserted into the storage space 84 from the oil injection port 76, and the amount and state of the oil in the storage space 84 can be checked by the oil level gauge 85.

Three communication holes 54 to 56 are formed in the back surface of the down frame 14, and the inner sides of the down frame 14 and the reinforcement 71 are connected to each other through the communication holes 54 to 56. The communication hole 54 to 56 promotes the movement of the oil between the down frame 14 and the reinforcement 71. The uppermost communication hole 54 is formed in a long hole shape, and the remaining two communication holes 55 and 56 are formed in a circular shape. The communication hole 54 having the long hole shape is the largest among the three communication holes 54 to 56. Such communication holes 54 to 56 make it easy to move not only the oil on the upper side of the reinforcement 71 but also the oil on the lower side of the reinforcement 71 to the down frame 14.

The oil inlet 75 is directed toward the communication hole 54 having the long hole shape, and the communication hole 54 having the long hole shape is positioned on the extension line of the oil injection port 76. That is, the communication hole 54 having the long hole shape is formed on the lower side of the oil injection port 76 in the insertion direction of the oil level gauge 85, so that the oil level gauge 85 provided in the oil injection port 76 easily enters the communication hole 54. Since the circular communication holes 55 and 56 other than the communication hole 54 having the long hole shape have a minimum size, a decrease in the strength of the down frame 14 due to the communication holes 55 and 56 is prevented, and the frame rigidity of the vehicle body frame 10 is sufficiently ensured.

The interval between the rear surface of the down frame 14 and the rear surface of the reinforcement 71 decreases downward, and the lowermost communication hole 56 is formed in the rear surface of the down frame 14 facing the lower end portion of the rear surface of the reinforcement 71. The inner lower end portion of the reinforcement 71 is connected to the inner side of the down frame 14 through the communication hole 56, and the oil stored in the inner lower end portion of the reinforcement 71 is also moved to the inner side of the down frame 14. Since the facing interval between the rear surfaces of the down frame 14 and the reinforcement 71 decreases toward the communication hole 56, the oil on the inner side of the reinforcement 71 is smoothly guided to the communication hole 56.

A connection port 73 to which the oil hose 82 (see FIG. 3) for collection is connected is formed in the upper portion of the reinforcement 71. The oil is returned from the crankcase 36 to the inner side of the reinforcement 71 (the oil tank) through the oil hose 82. The lower end surface of the down frame 14 is provided with the connection portion 51 to which the supply oil hose 83 is connected. A strainer 53 is provided at the suction port of the connection portion 51, and the oil is filtered by passing through the strainer 53. The oil is fed from the inner side of the down frame 14 (the oil tank) to the lower portion of the crankcase 36 through the oil hose 83.

In the frame structure implemented as described above, first, the sub COMP of the vehicle body frame 10 is formed by the head pipe 11, the down frame 14, the reinforcement 71, the rear plate 16, the left and right rail plates 65, and the oil inlet 75. After the leak test is performed in the sub COMP of the vehicle body frame 10, the left and right tank rails 12 are connected to the left and right rail plates 65, and the left and right tank rails 12 are connected to the reinforcement 71 via the left and right bridge tubes 19. The body frame 13 is connected to the down frame 14 via the under loop 15 to form the frame COMP.

As described above, according to the frame structure in the present embodiment, since the left and right tank rails 12 do not constitute the oil tank, the number of components of the oil tank is reduced, the connecting portion is minimized, and the airtightness is easily ensured. Since the leak test can be performed in the sub COMP state in which the tank rail 12 can be connected later, it is possible to reduce the work load of the worker due to the miniaturization of the test device and the weight reduction of the frame. The rigidity of the frame is increased by the oil inlet 75 penetrating the rear plate 16 and the oil inlet 75 functioning as a reinforcing member.

In the present embodiment, the rear surface of the reinforcement approaches the rear surface of the down frame downward. Alternatively, the shape of the reinforcement may be appropriately changed according to the shape of the fuel tank.

In the present embodiment, the rear plate is formed by connecting the upper surface plate, the lower surface plate, and the rear surface plate. Alternatively, the rear plate may be formed such that the left and right tank rails can be connected on the upper rear side of the head pipe.

In the present embodiment, the upper surface of the reinforcement is closed by the rear plate and the left and right rail plates. Alternatively, the upper surface of the reinforcement may be closed only by the rear plate.

In the present embodiment, three communication holes are formed in the rear surface of the down frame. Alternatively, one or two communication holes may be formed in the rear surface of the down frame, or four or more communication holes may be formed in the rear surface of the down frame.

In the present embodiment, the uppermost communication hole among the plurality of communication holes of the down frame is located on the extension line of the oil injection port. Alternatively, any communication hole among the plurality of communication holes of the down frame may be located on the extension line of the oil injection port.

The frame structure according to the present embodiment is not limited to being used in the off-road type straddle-type vehicle described above, and may be used in other types of straddle-type vehicles. The straddle-type vehicle is not limited to a general vehicle in which a driver rides on a seat in a posture of straddling the seat, and includes a scooter-type vehicle in which the driver rides on the seat without straddling the seat.

As described above, a first aspect is a frame structure of a straddle-type vehicle (1) using a vehicle body frame (10) as an oil tank, the frame structure including: a head pipe (11) located at a front portion of the vehicle body frame; a rear plate (16) configured to connect left and right tank rails (12) at an upper rear side of the head pipe; a tubular down frame (14) extending downward from a lower rear side of the head pipe; a reinforcement (71) connected to a rear surface of the down frame below the rear plate; and an oil inlet (75) attached to the rear plate and forming an oil injection port (76), in which an oil storage space (84) is formed on inner sides of the down frame and the reinforcement, and in which the oil inlet penetrates the rear plate and enters the storage space. According to this configuration, since the left and right tank rails do not constitute the oil tank, the number of components of the oil tank is reduced, the connecting portion is minimized, and the airtightness is easily ensured. Since the leak test can be performed in the sub COMP state in which the tank rail can be connected later, it is possible to reduce the work load of the worker due to the miniaturization of the test device and the weight reduction of the frame. The rigidity of the frame is increased by the oil inlet penetrating the rear plate and the oil inlet functioning as a reinforcing member.

A second aspect is directed to the first aspect, in which left and right rail plates (65) are connected to the rear plate, and the left and right tank rails are to be connected to the rear plate via the left and right rail plates, and in which an upper surface of the reinforcement is closed by the rear plate and the left and right rail plates. According to this configuration, the leak test can be performed in the sub COMP state of the vehicle body frame, and it is possible to reduce the work load of the worker due to the miniaturization of the test device and the weight reduction of the frame.

A third aspect is directed to the first and second aspects, in which the reinforcement is provided with a pedestal (72) to which left and right bridges (bridge tubes 19) configured to connect the reinforcement and the left and right tank rails are to be connected. According to this configuration, the frame rigidity is ensured by connecting the down frame and the reinforcement via the left and right bridges. The left and right bridges are connected not to the down frame but to the reinforcement, so that the bridge tube is less likely to affect the layout of the peripheral components of the down frame, and an increase in the size of the vehicle body can be avoided.

A fourth aspect is directed to the third aspect, in which an installation space for a radiator (37) is ensured on both sides of the down frame, and the pedestal is provided on a rear surface of the reinforcement. According to this configuration, it is not necessary to move the radiator forward of the down frame or separate the radiator outward from the down frame in the vehicle width direction, and an increase in the wheel base and the vehicle width dimension can be prevented.

A fifth aspect is directed to any one of the first to fourth aspects, in which a communication hole (54 to 56) connecting the inner sides of the down frame and the reinforcement is formed in the down frame, and in which the communication hole is located on an extension line of the oil injection port. According to this configuration, the amount of oil can be checked by the oil level gauge provided at the oil injection port while promoting the movement of the oil between the down frame and the reinforcement.

A sixth aspect is directed to the fifth aspect, in which the communication hole is a plurality of communication holes, and in which a largest communication hole (54) among the plurality of communication holes is located on the extension line of the oil injection port.

According to this configuration, it is possible to facilitate the entry of the oil level gauge while promoting the movement of the oil between the down frame and the reinforcement by the plurality of communication holes. The frame rigidity is ensured by forming the communication holes other than one communication hole to be small.

A seventh aspect is directed to any one of the first to sixth aspects, in which an interval between the rear surface of the down frame and a rear surface of the reinforcement decreases downward, and a communication hole connecting the inner sides of the down frame and the reinforcement is formed in the down frame facing a lower end portion of the rear surface of the reinforcement. According to this configuration, the inner lower end portion of the reinforcement is connected to the inner side of the down frame through the communication hole, and the oil stored in the inner lower end portion of the reinforcement is also moved to the inner side of the down frame. Since the facing interval between the rear surfaces of the down frame and the reinforcement decreases toward the communication hole, the oil on the inner side of the reinforcement is smoothly guided to the communication hole.

Although the present embodiment has been described, a part or all of the embodiment and modifications described above may be combined as another embodiment.

The technique according to the present invention is not limited to the embodiment described above, and may be variously changed, replaced, or modified without departing from the gist of the technical concept. Further, the present invention may be implemented by other methods as long as the technical concept can be implemented by the methods through advance of the technique or other derivative techniques. Therefore, the claims cover all embodiments that may fall within the scope of the technical concept.

What is claimed is:

1. A frame structure of a straddle-type vehicle in which a vehicle body frame is used as an oil tank, the frame structure comprising:
a head pipe located at a front portion of the vehicle body frame;
a rear plate connecting left and right tank rails, at an upper rear side of the head pipe;
a down frame having a tubular shape and extending downward from a lower rear side of the head pipe;
a reinforcement connected to a rear surface of the down frame, below the rear plate; and
an oil inlet attached to the rear plate and forming an oil injection port,
wherein an oil storage space is formed on inner sides of the down frame and the reinforcement, and
wherein the oil inlet penetrates the rear plate and enters the storage space.

2. The frame structure according to claim 1,
wherein left and right rail plates are connected to the rear plate, and the left and right tank rails are configured to be connected to the rear plate via the left and right rail plates, and
wherein an upper surface of the reinforcement is closed by the rear plate and the left and right rail plates.

3. The frame structure according to claim 1,
wherein the reinforcement is provided with a pedestal to which left and right bridges are to be connected, the left and right bridges being configured to connect the reinforcement and the left and right tank rails.

4. The frame structure according to claim 3,
wherein an installation space for a radiator is located on both sides of the down frame, and the pedestal is provided on a rear surface of the reinforcement.

5. The frame structure according to claim 1,
wherein a communication hole connecting the inner sides of the down frame and the reinforcement is formed in the down frame, and
wherein the communication hole is located on an extension line of the oil injection port.

6. The frame structure according to claim 5,
wherein the communication hole is a plurality of communication holes, and
wherein a largest communication hole among the plurality of communication holes is located on the extension line of the oil injection port.

7. The frame structure according to claim 1,
wherein an interval between the rear surface of the down frame and a rear surface of the reinforcement decreases downward, and
a communication hole connecting the inner sides of the down frame and the reinforcement is formed in the down frame facing a lower end portion of the rear surface of the reinforcement.
